(19) United States
(12) Patent Application Publication
(10) Pub. No.: US 2011/0314367 A1
(43) Pub. Date: Dec. 22, 2011

(54) System And Method For Annotating And Searching Media

(75) Inventors: Shih-Fu Chang, New York, NY (US); Jun Wang, New City, NY (US); Tony Jebara, New York, NY (US)

(73) Assignee: THE TRUSTEES OF COLUMBIA UNIVERSITY IN THE CITY OF NEW YORK, New York, NY (US)

(21) Appl. No.: 13/165,553

(22) Filed: Jun. 21, 2011

Related U.S. Application Data
(63) Continuation-in-part of application No. PCT/US09/69237, filed on Dec. 22, 2009.
(60) Provisional application No. 61/171,789, filed on Apr. 22, 2009.
(60) Provisional application No. 61/151,124, filed on Feb. 9, 2009.
(60) Provisional application No. 61/142,488, filed on Jan. 5, 2009.
(60) Provisional application No. 61/140,035, filed on Dec. 22, 2008.
(60) Provisional application No. 61/233,325, filed on Aug. 12, 2009.

(51) Int. Cl. G06F 17/20

(52) U.S. Cl. 715/230

(57) ABSTRACT

A system and method for labeling and classifying multimedia data is provided that includes novel label propagation techniques and classification function characteristics. The system and method corrects and propagates a small number of potentially erroneous labels to a large amount of multimedia data and generate optimal ways of ranking, classification, and presentation of the data sets. The disclosed systems and methods improve upon prior systems and methods and provide an improved approach to the problems of imbalanced data sets and incorrect label data.

### CROSS-REFERENCE TO RELATED APPLICATIONS

This application is a Continuation-In-Part of International Application PCT/US09/069,237, filed Dec. 22, 2009 and which claims priority to U.S. Provisional Application Nos. 61/140,035, filed on Dec. 22, 2008, entitled, “Active Microscopic Cellular Image annotation by Superposable Graph Transduction with Imbalance Labels”; 61/142,488, filed Jan. 5, 2009, entitled, “Graph Transduction via Alternating Minimization”; 61/151,124, filed on Feb. 9, 2009, entitled, “System and Method for Arranging Media”; 61/171,789, filed on Apr. 22, 2009, entitled “Rapid Image Annotation via Brain State Decoding and Visual Pattern Mining,”; and 61/233/325, filed Aug. 12, 2009, entitled, “System and Methods for Image Annotation and Label Refinement by Graph” which are incorporated herein by reference in their entirety.

### BACKGROUND OF THE INVENTION

As volumes of digital multimedia collections grow, means for efficient and accurate searching and retrieval of data from those collections have become increasingly important. As a result, tools such as multimedia labeling and classification systems and methods that allow users to accurately and efficiently sort and categorize such data have also become increasingly important. Unfortunately, previous labeling and classification methods and systems tend to suffer deficiencies in several respects, as they can be inaccurate, inefficient and/or incomplete, and are, accordingly, not sufficiently effective to address the issues associated with large collections of multimedia.

Various methods have been used to improve the labeling of multimedia data. For example, there has been work exploring the use of user feedback to improve the image retrieval experience. In such systems, relevance feedback provided by the user is used to indicate which images in the returned results are relevant or irrelevant to the users' search target. Such feedback can be indicated explicitly (by marking labels of relevance or irrelevance) or implicitly (by tracking specific images viewed by the user). Given such feedback information, the initial query can be modified. Alternatively, the underlying features and distance metrics used in representing and matching images can be refined using the relevance feedback information.

Applications in practical domains using prior methods and systems, however, have not proven sufficiently effective. The prior systems do not ensure that the refined query, feature, or metric will improve the capability of retrieving additional targets that may have been overlooked in the initial results. Additionally, these prior systems tend to yield inaccurate results in unbalanced labeling situations and are prone to “noisy results,” which can lead to confusing and ambiguous classifications.

Some graph based semi-supervised learning methods have been explored to improve the image annotation accuracy by utilizing the label information from the labels data samples as well as the distribution information of the large amount of unlabeled data samples—a semi-supervised learning setting. They typically define a continuous classification function FεR^{n×c} (n is the number of samples and c is the number of classes.) that is estimated on a graph representing the data samples to minimize a regularized cost function. The cost function commonly involves a tradeoff between the smoothness of the function over the graph of both labeled and unlabeled data and the accuracy of the function in fitting the label information for the labeled nodes. The performance of the existing systems is inadequate since the optimization process only considers the classification function as the search variable, which makes the performance highly sensitive to several well known problems such as label class unbalance, extreme locations of the labeled data samples in the feature space, noisy data samples, as well as unreliable labels received as input.

### SUMMARY

It is therefore an object of the presently disclosed subject matter to provide improved methods and systems for retrieving and labeling multimedia files.

Certain embodiments of the disclosed subject matter are designed to facilitate rapid retrieval and exploration of image and video collections. The disclosed subject matter incorporates novel graph-based label propagation methods and intuitive graphic user interfaces (“GUIs”) that allow users to quickly browse and annotate a small set of multimedia data, and then in real or near-real time provide refined labels for all remaining unlabeled data in the collection. Using such refined labels, additional positive results matching a user's interest can be identified. Such a system can be used as a fast search system alone, or as a bootstrapping system for developing additional target recognition tools needed in critical image application domains such as in intelligence, surveillance, consumer applications, biomedical applications, and in Internet applications.

Starting with a small number of labels provided by users or other sources, certain disclosed systems and methods can be implemented to propagate the initial labels to the remaining data and predict the most likely labels (or scores) for each data point on the graph. The propagation process is optimized with respect to several criteria. For example, the system may be implemented to consider factors such as: how well the predictions fit the already-known labels; the regularity of the predictions over data in the graph; the balance of labels from different classes; if the results are sensitive to quality of the initial labels and specific ways the labeled data are selected.

Certain disclosed system and method embodiments can be used in different modes—for example, interactive and automatic modes. An interactive mode can be designed for applications in which a user uses the GUI to interact with the system in browsing, labeling, and providing feedback. An automatic mode can use the initial labels or scores produced by other processes and then output refined scores or labels for all the data in the collection. The processes providing the initial labels may come from various sources, such as other classifiers using different modalities (for example, text, visual, or metadata), models (for example, supervised computer vision models or brain computer interface), or features, rank information regarding the data from other search engines, or even other manual annotation tools. In some systems and methods, when dealing with labels/scores from imperfect sources (e.g., search engines), additional steps may be implemented to filter the initial labels and assess their reliability before using them as inputs for the propagation process.

The output of the disclosed system embodiments may consist of refined or predicted labels (or scores indicating likelihood of positive detection) of some or all the images in the collection. These outputs can be used to identify additional positive samples matching targets of interest, which in turn can be used for a variety of functions, such as to train more robust classifiers, arrange the best presentation order for image browsing, or rearrange image presentations.

In a disclosed embodiment of a system and method in accordance with the disclosed subject matter, a partially labeled multimedia data set is received and an iterative graph-based optimization method is employed resulting in improved label propagation results and an updated data set with refined labels.

Embodiments of the disclosed systems and methods are able to handle label sets of unbalanced class size and weigh labeled samples based on their degrees of connectivity or other importance measures.

In another disclosed embodiment of a system and method in accordance with the disclosed subject matter, noisy labels can be removed based on a greedy search among gradient directions of a cost function.

In certain embodiments of the disclosed methods and systems, after the propagation process is completed, the predicted labels of all the nodes of the graph can be used to determine the best order of presenting the results to the user. For example, the images may be ranked in the database in a descending order of likelihood so that user can quickly find additional relevant images. Alternatively, the most informative samples may be displayed to the user to obtain the user's feedback, so that the feedback and labels may be collected for those critical samples. These functions can be useful to maximize the utility of the user interaction so that the best prediction model and classification results can be obtained with the least amount of manual user input.

The graph propagation process may also be applied to predict labels for new data that is not yet included in the graph. Such processes may be based, for example, on nearest neighbor voting or some form of extrapolation from an existing graph to external nodes.

In some embodiments of the disclosed subject matter, to implement an interactive and real-time system and method, the graph based label propagation may use a novel graph superposition method to incrementally update the label propagation results, without needing to repeat computations associated with previously labeled samples.

### BRIEF DESCRIPTION OF THE DRAWINGS

Further objects, features, and advantages of the presently disclosed subject matter will become apparent from the following detailed description taken in conjunction with the accompanying figures showing illustrative embodiments of the disclosed subject matter, in which:

FIG. 1 is a diagram illustrating exemplary multimedia-processing system modes in accordance with the presently disclosed subject matter;

FIG. 2 is a diagram illustrating one exemplary TAG system hardware configuration;

FIG. 3 is diagram illustrating an exemplary system graphic user interface (GUI) in accordance with the presently disclosed subject matter;

FIG. 4 is a flow chart illustrating an exemplary labeling propagation and refining method in accordance with the presently disclosed subject matter;

FIG. 5 is a diagram illustrating a fraction of a constructed graph and computation of a node regularizer method in accordance with the presently disclosed subject matter;

FIG. 6 is a flow chart illustrating an exemplary labeling diagnosis method in accordance with the presently disclosed subject matter.

FIG. 7 is a diagram illustrating the use of multiple graphs to represent the data to retrieved and labeled.

FIG. 8 is a graph comparing the performance of the disclosed subject matter as applied to a test dataset.

### DETAILED DESCRIPTION

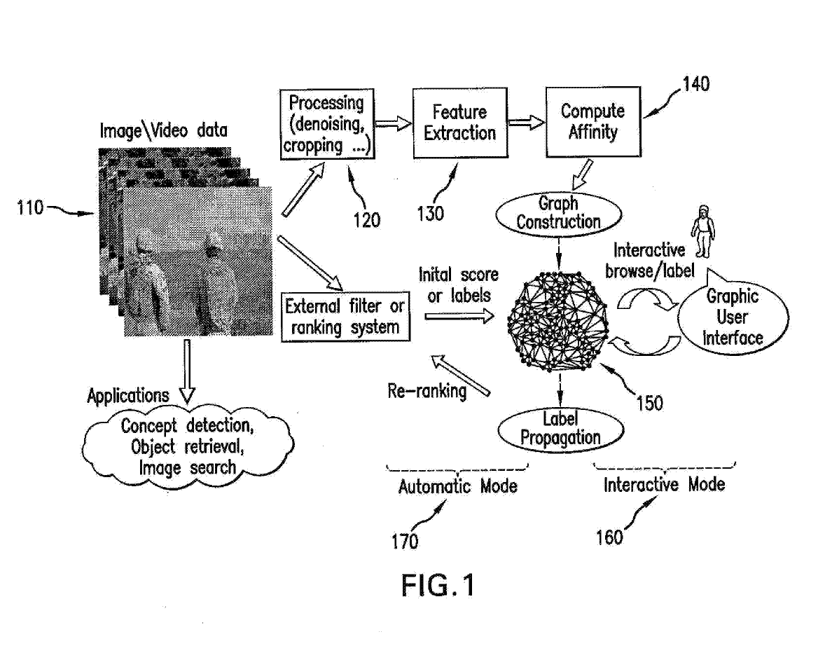

Transductive annotation by graph (“TAG”) systems and methods as disclosed herein can be used to overcome the labeling and classification deficiencies of prior systems and methods described above. FIG. 1 illustrates a TAG system and various exemplary usage modes in accordance with the presently disclosed subject matter.

Given a collection of multimedia files, the TAG system of FIG. 1 can be used to build an affinity graph to capture the relationship among individual images, video, or other multimedia data. The affinity between multimedia files may be represented as, for example: a continuous valued similarity measurement or logic associations (e.g., relevance or irrelevance) to a query target, or other constraints (e.g., images taken at the same location). The graph can also be used to propagate information from labeled data to unlabeled data in the same collection.

As illustrated in FIG. 1, each node in the graph 150 may represent a basic entity (data sample) for retrieval and annotation. In certain embodiments, nodes in the graph 150 may be associated with either a binary label (e.g., positive vs. negative) or a continuous-valued score approximating the likelihood of detecting a given target. The represented entity may be, for example, an image, a video clip, a multimedia document, or an object contained in an image or video. In an ingestion process, each data sample may first be pre-processed 120 (e.g., using operations such as scaling, partitioning, noise reduction, smoothing, quality enhancement, and other operations as are known in the art). Pre-filters may also be used to filter likely candidates of interest (e.g., images that are likely to contain targets of interest). After pre-processing and filtering, features may be extracted from each sample 130. TAG systems and methods in accordance with the disclosed subject matter do not necessarily require usage of any specific features. A variety of feature sets preferred by practical applications may be used. For example, feature sets may be global (e.g., color, texture, edge), local (e.g., local interest points), temporal (e.g. motion), and/or spatial (e.g., layout). Also, multiple types and modalities of features may be aggregated or combined. Given the extracted features, affinity (or similarity) between each pair of samples is computed 140. No specific metrics are required by TAG, though judicious choices of features and similarity metrics may significantly impact the quality of the final label prediction results. The pair-wise affinity values can then be assigned and used as weights of the corresponding edges in the graph 150. Usually, weak edges with small weights are pruned to reduce the complexity of the affinity graph 150. Alternatively, a fixed number of edges may be set for each node by finding a fixed number of nearest neighbors for each node.

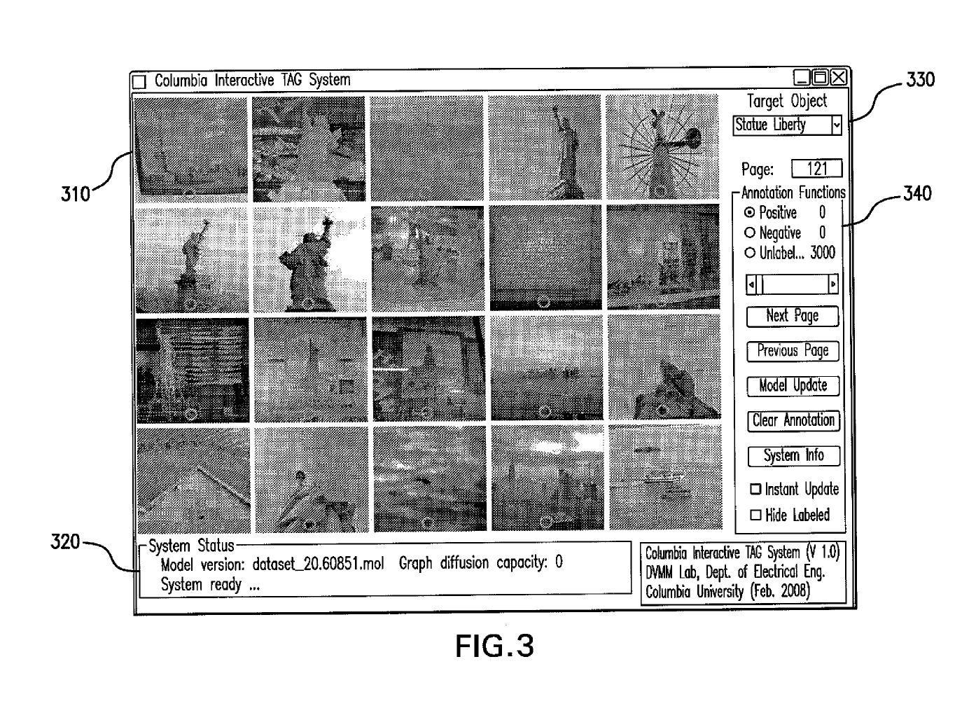

Once the affinity graph 150 is created, a TAG system can be used for retrieval and annotation. A variety of modes and usages could be implemented in accordance with the teachings of the presently disclosed subject matter. Two possible modes include: interactive 160 and automatic 170 modes. In the Interactive Mode 160, users may browse, view, inspect, and label images or videos using a graphic user interface (GUI), an embodiment of which is described in more detail hereinafter in connection with FIG. 3.

Initially, before any label is assigned, a subset of default data may be displayed in the browsing window of the GUI based on, for example, certain metadata (e.g., time, ID, etc.) or a random sampling of the data collection. Using the GUI, a user may view an image of interest and then provide feedback about relevance of the result (e.g., marking the image as “relevant” or “irrelevant” or with multi-grade relevance labels). Such feedback can then be used to encode labels which are assigned to the corresponding nodes in the graph.

In Automatic Mode 170, the initial labels of a subset of nodes in the graph may be provided by external filters, classifiers, or ranking systems. For example, for a given target, an external classifier using image features and computer vision classification models may be used to predict whether the target is present in an image and assign the image to the most likely class (positive vs. negative or one of multiple classes). As another example, if the target of interest is a product image search for web based images, external web image search engines may be used to retrieve most likely image results using a keyword search. The rank information of each returned image can then be used to estimate the likelihood of detecting the target in the image and approximate the class scores which can be assigned to the corresponding node in the graph.

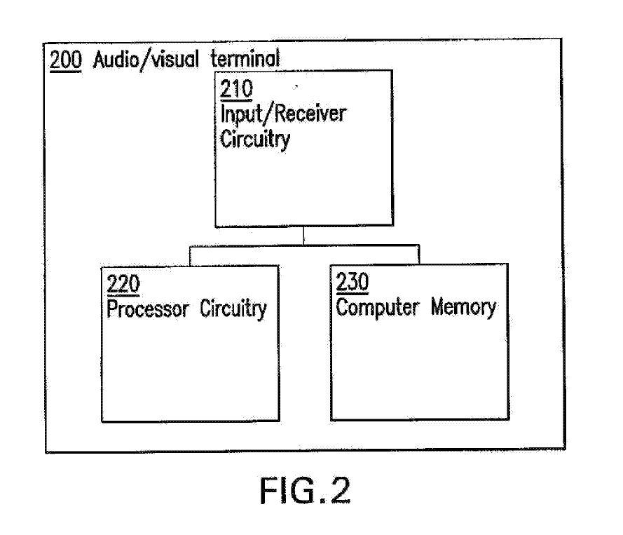

FIG. 2 shows an exemplary TAG system hardware configuration in accordance with the disclosed subject matter. In this particular embodiment, the system includes an audio-visual (AV) terminal 200, which may be used to form, present or display audio-visual content. Such terminals may include (but are not limited to) end-user terminals equipped with a monitor screen and speakers, as well as server and mainframe computer facilities in which audio-visual information is processed. In such an AV terminal, desired functionality can be achieved using any combination of hardware, firmware or software, as would be understood by one of ordinary skill in the art. The system may also include input circuitry 210 for receiving information to be processed. Information to be processed may be furnished to the terminal from a remote information source via a telecommunications channel, or it may be retrieved from a local archive, for example. The system further may include processor circuitry 220 capable of processing the multimedia and related data and performing computational algorithms. Additionally, the disclosed system may include computer memory 230, comprising RAM, ROM, hard disk, cache memory, buffer memory, tape drive, or any other computer memory media capable of storing electronic data. Notably, the memory chosen in connection with an implementation of the claimed subject matter can be a single memory or multiple memories, and can be comprised of a single computer-readable medium or multiple different computer-readable media, as would be understood by one of ordinary skill in the art. One of ordinary skill in the art would understand a variety of different configurations of such a system, including a general purpose personal computer programmed with software sufficient to enable the methods of the disclosed subject matter described herein.

FIG. 3 shows an exemplary TAG system GUI in accordance with the presently disclosed subject matter. The disclosed GUI may include a variety of components. For example, image browsing area 310, as shown in the upper left corner of the GUI, may be provided to allow users to browse and label images and provide feedback about displayed images. During the incremental annotation procedure, the image browsing area can present the top ranked images from left to right and from top to bottom, or in any other fashion as would be advantageous depending on the particulars of the application. System status bar 320 can be used to display information about the prediction model used, the status of current propagation process and other helpful information. The system processing status as illustrated in FIG. 3 may provide system status descriptions such as, for example, ‘Ready’, ‘Updating’ or ‘Re-ranking.’ The top right area 330 of the GUI can be implemented to indicate the name of current target class, e.g., “statue of liberty” as shown in FIG. 3. For semantic targets that do not have prior definition, this field may be left blank or may be populated with general default text such as “target of interest.” Annotation function area 340 may be provided below the target name area 330. In this embodiment, a user can choose from labels such as ‘Positive’, ‘Negative’, and ‘Unlabeled.’ Also, statistical information, such as the number of positive, negative and unlabeled samples may be shown. The function button in this embodiment includes labels ‘Next Page’, ‘Previous Page’, ‘Model Update’, ‘Clear Annotation’, and ‘System Info.’

Various additional components and functions may be implemented in accordance with a system and method of the disclosed subject matter. For example, image browsing functions may be implemented in connection with such a system and method. After reviewing the current ranking results or the initial ranking, in this embodiment, such functionality may be implemented to allow a user to browse additional images by clicking the buttons ‘Next Page’ and ‘Previous Page.’ Additionally, a user may also use the sliding bar to move through more pages at once. Manual annotation functions may also be implemented in connection with a system and method in accordance with the disclosed subject matter. In certain embodiments, after an annotation target is chosen, the user can annotate specific images by clicking on them. For example, in such a system, positive images may be marked with a check mark, negative images may be marked with a cross mark ‘x’, and unlabeled images may be marked with a circle ‘◯’.

Automatic propagation functions may also be implemented in connection with a system and method in accordance with the disclosed subject matter. In certain embodiments, after a user inputs some labels, clicking the button ‘Model Update’ can trigger the label propagation process and the system will thereafter automatically infer the labels and generate a refined ranking score for each image. A user may reset the system to its initial status by clicking the button labeled ‘Clear Annotation.’ A user may also click the button labeled ‘System Info’ to generate system information, and output the ranking results in various formats that would be useful to one of ordinary skill in the art, such as, for example, a MATLAB-compatible format.

In the GUI embodiment shown in FIG. 3, two auxiliary functions are provided which are controlled by checking boxes ‘Instant Update’ and ‘Hide Labels.’ When a user selects ‘Instant Update,’ the shown system will respond to each individual labeling operation and instantly update the ranking list. The user can also hide the labeled images and only show the ranking results of unlabeled images by checking ‘Hide Labels.’

Given assigned labels or scores for some subset of the nodes in the graph (the subset is usually but not necessarily a small portion of the entire graph), embodiments of the disclosed systems can propagate the labels to other nodes in the graph accurately and efficiently.

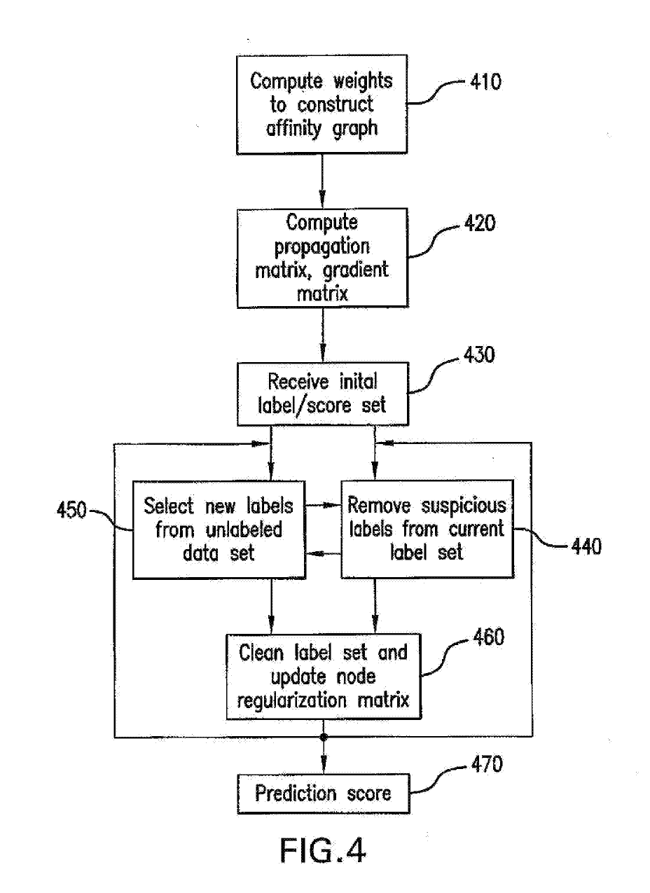

FIG. 4 is a flow chart illustrating a labeling propagation method in accordance with an exemplary implementation of the presently disclosed subject matter. In step 410, the similarity or association relations between data samples are computed or acquired to construct an affinity graph. In step 420, some graph quantities, including a propagation matrix and gradient coefficient matrix are computed based on the affinity graph. In step 430, an initial label or score set over a subset of graph data is acquired. In various embodiments, this can be done via either interactive or automatic mode, or by some other mode implemented in connection with the disclosed subject matter. In step 440, one or more new labels are selected and added to the label set. Step 450 is an optional step in which one or more unreliable labels are selected and removed from the existing label set. In step 460, cleaned label set are obtained and a node regularization matrix is updated to handle the unbalanced class size problem of label data set. Steps 440, 450, and 460 may be repeated until a certain number of iterations or some stop criteria are met. In step 470, the final classification function and prediction scores over the data samples are computed.

Additional description of algorithms and graph data generally described above is now provided. In an embodiment in accordance with the disclosed subject matter, an image set X=(X_{L}, X_{U}) may consist of labeled samples X_{L}={xₗ, . . . , xₗ} and unlabeled samples X_{U}={sₗ₊₁, . . . , xₙ}, where/is the number of labels. The corresponding labels for the labeled data set may be denoted as {y₁, . . . , yₗ}, where yε{l, . . . , c} and c is the number of classes. For transductive learning, an objective is to infer the labels {yₗ₊₁, . . . , yₙ} of the unlabeled data X_{U}={xₗ₊₁, . . . , xₙ}, where typically l<<n, namely only a very small portion of data are labeled. Embodiments may define an undirected graph represented by G={X,E}, where the set of node or vertices is X={xᵢ} and the set of edges is E={eᵢⱼ}. Each sample x, may be treated as the node on the graph and the weight of edge eᵢⱼ can be represented as wᵢⱼ. Typically, one uses a kernel function k(·) over pairs of points to calculate weights, in other words wᵢⱼ=k(xᵢ,xⱼ) with the RBF kernel being a popular choice. The weights for edges may be used to build a weight matrix which may be denoted by W={wᵢⱼ}. Similarly, the node degree matrix D=diag(d₁, . . . , dₙ) may be defined as

$${d}_{l} = {\sum }_{j = l}^{n} {W}_{ij} .$$

An graph related quantity Δ=D−W is called graph Laplacian and its normalized version is

$$L = {D}^{- \frac{1}{2}} Δ {D}^{- \frac{1}{2}} = I - {D}^{- \frac{1}{2}} {WD}^{- \frac{1}{2}} = I - S$$

where

$$S = {D}^{- \frac{1}{2}} {WD}^{- \frac{1}{2}} .$$

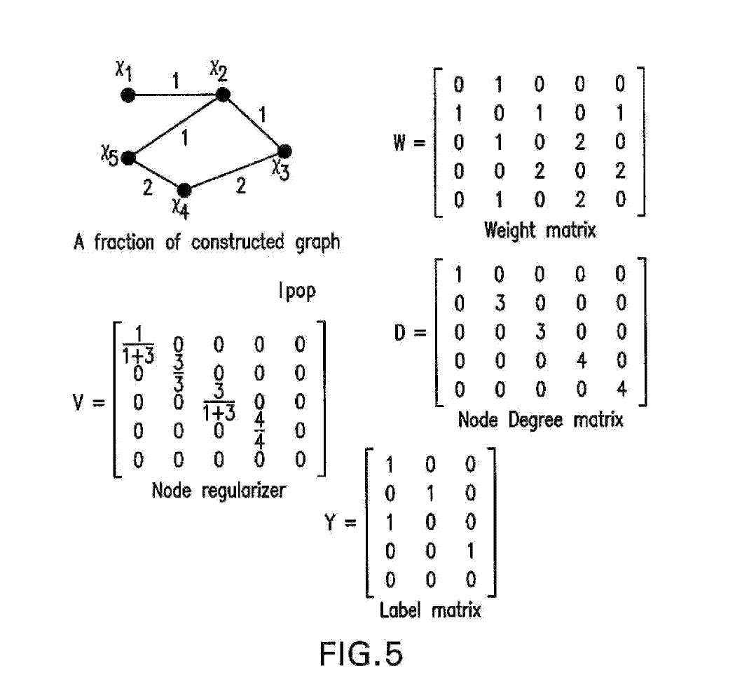

The binary label matrix Y may be described as YεB^{n×c} with Yᵢⱼ=1 if xᵢ has label yᵢ=j (means data x, belongs to class j) and Yᵢⱼ=0 otherwise (means data xᵢ is unlabeled). A data sample may belong to multiple classes . simultaneously and thus multiple elements in the same row of Y can be equal to 1. FIG. 5 shows a fraction of a representative constructed graph with weight matrix W, node degree matrix D, and label matrix Y. A classification function F, can then be estimated on the graph to minimize a cost function. The cost function typically enforces a tradeoff between the smoothness of the function over the graph and the accuracy of the function at fitting the label information for the labeled nodes.

Embodiments of the disclosed TAG systems and methods may implement novel approaches to improving the quality of label propagation results. For example, disclosed embodiments may include: 1) superposition law based incremental label propagation; 2) a node regularizer for balancing label imbalance and weighting label importance; 3) alternating minimization based label propagation; 4) label diagnosis through self tuning. The details of disclosed embodiments of the disclosed systems and methods will be described in the following paragraphs.

Embodiments of the disclosed TAG systems and methods can also include a novel incremental learning method that allows for efficient addition of newly labeled samples. Results can be quickly updated using a superposition process without repeating the computation associated with the labeled samples already used in the previous iterations of propagation. Contributions from the new labels can be easily added to update the final prediction results. Such incremental learning capabilities are important for achieving real-time responses to a user's interaction. Since the optimal prediction can be decomposed into a series of parallel problems, and the prediction score for individual class can be formulated as component terms that only depend on individual columns of a classification matrix F.

$$F = {( I - α S )}^{- 1} {\sum }_{i = 1}^{l} {\hat{Y}}_{i} = {\sum }_{i = 1}^{l} {( I - α \hat{S} )}^{- 1} {Y}_{i} = {\sum }_{i = 1}^{l} {\hat{F}}_{i}$$

where αε(0,1) is a constant parameter. Because each column of F encodes the label information of each individual class, such decomposition reveals that biases may arise if the input labels are disproportionately imbalanced. Prior propagation algorithms often fail in this unbalanced case, as the results tend to be biased towards the dominant class. To overcome this problem, disclosed embodiments of the disclosed systems and methods apply a novel graph regularization method to effectively address the class imbalance issue. Specifically, in disclosed embodiments, each class may be assigned an equal amount of weight and each member of a class may be assigned a weight (termed as node regularizer) proportional to its connection density and inversely proportional to the number of samples sharing the same class.

$$F = {\sum }_{i = 1}^{l} \hat{{v}_{ii} {F}_{i}} = {\sum }_{i = 1}^{l} \hat{{( I - α S )}^{- 1} {v}_{ii} {Y}_{i}} = {( I - α S )}^{- 1} VY$$

where the diagonal matrix V={vᵢᵢ} is introduced as a node regularizer to balance the influence of labels from different classes. Assume sample xᵢ is associated with label j, the value of vᵢᵢ is computed as:

$${v}_{ii} = {d}_{i} / {\sum }_{k = 1}^{l} {d}_{k} {Y}_{kj}$$

where d₁ is the node degree of labeled sample xᵢ and

$${\sum }_{k = 1}^{l} {d}_{k} {Y}_{kj}$$

is the sum of node degree of the labeled nodes in class j. FIG. 5 illustrates the calculation of node regularizer on a fraction of an exemplary constructed graph. The node weighting mechanism described above allows labeled nodes with a high degree to contribute more during the graph diffusion and label propagation process. However, the total diffusion of each class can be kept equal and normalized to be one. Therefore the influence of different classes can be balanced even if the given class labels are unbalanced. If class proportion information is known beforehand, it can be integrated into particular systems and methods by scaling the diffusion with the prior class proportion. Because of the nature of graph transduction and unknown class prior knowledge, however, equal class balancing leads to generally more reliable solutions than label proportional weighting.

Along with the node regularizer, incremental learning by superposition law is described here as another embodiment of the disclosed systems and methods. Let

$${D}_{j} = {\sum }_{k = 1}^{l} {d}_{k} {Y}_{kj}$$

denotes the total degree of the current labels in class j. Adding a new labeled sample xₛ (the corresponding degree is dₛₛ) to class j, two coefficients λ, γ can be calculated as:

$$λ = \frac{{D}_{j}}{{D}_{j} + {d}_{ss}}$$

$$γ = \frac{{d}_{ss}}{{D}_{j} + {d}_{ss}}$$

Then the new prediction score for class j can be rapidly computed as:

F_{·j}^{new}=λF_{·j}+γP_{·s}

where F_{·j} is the j th column of the classification matrix F and P_{·s} is the j th column of the propagation matrix P (The propagation matrix will be defined later). This is in contrast to a brute force approach that uses the whole set of labeled samples, including the new labeled sample and the existing labeled samples, to calculate the classification function from scratch again. The disclosed systems and methods result in a much more efficient implementation of the label propagation process.

Certain embodiments of the disclosed systems and methods make modifications to the cost function used in previously used systems and methods. For example, in certain systems and methods, the optimization is explicitly shown over both the classification function F and the binary label matrix Y:

(F*,Y*)=arg min_{FεR}_{^{n×c}}_{,YεB}_{^{n×c}}Q(F,Y)

where B is the set of all binary matrices Y of size n×c that satisfy Σⱼ Yᵢⱼ=1 for a single labeling problem, and for the labeled data xᵢεXₗ, Yᵢⱼ=1 if yᵢ=j. However, embodiments of the disclosed systems and methods naturally adapt to a multiple-label problem, where single multimedia file may be associated with multiple semantic tags. More specifically, the loss function is:

$$Q ( F , Y ) = \frac{1}{2} tr \{ {F}^{T} LF + μ {( F - VY )}^{T} ( F - VY ) \}$$

where the parameter μ balances two parts of the cost function. The node regularizer V permits the use of a normalized version of the label matrix Z defined as: Z=VY. By definition, in certain embodiments, the normalized label matrix satisfies Σᵢ Zij=1.

An alternating minimization procedure to solve the above optimization problem can also contribute to improvements over prior methods and systems, as disclosed herein. Specifically, the cost function discussed above includes two variables that can be optimized. While simultaneously recovering both solutions can be difficult due to the mixed -integer programming problem over binary Y and continuous F, a greedy alternating minimization approach may be used instead. The first update of the continuous classification function F is straightforward since the resulting cost function is convex and unconstrained, which allows the optimal F. to be recovered by setting the partial derivative

$$\frac{\partial Q}{\partial F}$$

equal to zero. However, since YεB^{n·c} is a binary matrix and subject to certain linear constraints, the other step in another embodiment of the disclosed alternating minimization requires solving a linearly constrained max cut problem which is NP. Due to the alternating minimization outer loop, investigating guaranteed approximation schemes to solve a constrained max cut problem for Y may be unjustified due to the solution's dependence on the dynamically varying classification function F during an alternating minimization procedure. Instead, embodiments of the currently disclosed methods and systems may use a greedy gradient-based approach to incrementally update Y while keeping the classification function F at the corresponding optimal setting. Moreover, because the node regularizer term V normalizes the labeled data, updates of V can be interleaved based on the revised Y.

The classification function, FεR^{n·c}, as used in certain embodiments of the disclosed subject matter, is continuous and its loss terms are convex, which allows its minimum to be recovered by zeroing the partial derivative:

$$\begin{matrix}\frac{\partial Q}{\partial F} = 0 ⇒ LF + μ ( {F}^{*} - VY ) = 0 \\ ⇒ F *= {( L / μ + I )}^{- 1} VY = PVY\end{matrix}$$

where P=(L/μ+I)⁻¹ is denoted as the propagation matrix and may assume the graph is symmetrically built. To update Y, first Y can be replaced by its optimal value F* as shown in the equation above. Accordingly:

$$\begin{matrix}Q ( Y ) = \frac{1}{2} tr ( {Y}^{T} {V}^{T} {P}^{T} LPVY + \\ {μ ( pVY - VY )}^{t} ( PVY - VY ) ) \\ = \frac{1}{2} tr ( {Y}^{T} {V}^{T} [ {P}^{T} LP + μ ( {P}^{t} - I ) ( P - I ) ] VY )\end{matrix}$$

This optimization still involves the node regularizer V, which depends on Y and normalizes the label matrix over columns. Due to the dependence on the current estimate of F and V, only an incremental step will be taken greedily in certain disclosed embodiments to reduce Q(Y). In each iteration, position (i*, j*) in the matrix Y can be found and the binary value Y_{i*j*} of can be changed from 0 to 1. The direction with the largest negative gradient may guide the choice of binary step on Y. Therefore,

$$\frac{\partial Q}{\partial Y}$$

can be evaluated and the associated largest negative value can be found to determine (i*, j*).

Note that Setting Y_{i*j*}=1 is Equivalent to a Similar Operation on the normalized label matrix Z by setting Z_{i*j*}=ε0<ε<1, and Y, Z to have one-to-one correspondence. Thus, the greedy minimization of Q with respect to Y in this disclosed embodiment is equivalent to the greedy minimization of Q with respect to Z:

$$( {i}^{*} , {j}^{*} ) = arg {min}_{i , j} \frac{\partial Q}{\partial Z}$$

The loss function can be rewritten using the variable Z as:

$$Q ( Z ) = \frac{1}{2} tr ( {Z}^{T} [ {P}^{T} LP + μ ( {P}^{T} - I ) ( P - I ) ] Z ) = \frac{1}{2} tr ( {Z}^{T} AZ )$$

where A represents A=P^{T} LP+μ(P^{T}−I)(P−I). Note that A is symmetric if the graph is symmetrically built. The gradient of the above loss function can be derived and recovered with respect to Z as:

$$\frac{\partial Q}{\partial Z} = AZ = A \cdot VY .$$

As described earlier, the gradient matrix can be searched to find the minimal element for updating the following equation:

(i*,j*)=arg min_{xεX}_{ᵤ}_{, 1≦j≦c}∇_{z}_{ᵢⱼ}Q

The label matrix can be updated by setting Y_{i*j*}=1. Because of the binary nature of Y, Y_{i*j*} can be set to equal 1 instead of using a continuous gradient approach. Accordingly, after each iteration, the node regularizer can be recalculated using the updated label matrix.

The updated Y in accordance with certain disclosed embodiments is greedy and could therefore oscillate and backtrack from predicted labeling in previous iterations without convergence guarantees. To guarantee convergence and avoid backtracking, inconsistency or unstable oscillation in the greedy propagation of labels, in preferred embodiments, once an unlabeled point has been labeled, its labeling can no longer be changed. In other words, the most recently labeled point (i*, j*) is removed from future consideration and the algorithm only searches for the minimal gradient entries corresponding to the remaining unlabeled samples. Thus, to avoid changing the labeling of previous predictions, the new labeled node xᵢ may be removed from Xᵤ and added to Xₗ.

The following equations summarize the updating rules from step l to l+1 in certain embodiments of the scheme of graph transduction via alternative minimization (GTAM). Although the optimal F* can be computed in each iteration, it does not need to explicitly be updated. Instead, it can be implicitly used to directly updated Y:

$${∇}_{Z} {Q}^{t} = A \cdot {V}^{t} {Y}^{t} \\ ( {i}^{*} , {j}^{*} ) = arg {min}_{{x}_{i} ∈ {X}_{u} , 1 \leq j \leq c} {∇}_{{Z}_{ij}} {Q}^{t}$$

$${Y}_{{i}^{*} {j}^{*}}^{t + 1} = 1$$

$${v}_{ii}^{t + 1} = {d}_{i} / {\sum }_{k = 1}^{l} {d}_{k} {Y}_{kj}^{t + 1}$$

$${X}_{U}^{t + 1} ← {X}_{L}^{t} + {x}_{{i}^{*}} ;$$

$${X}_{U}^{t + 1} ← {X}_{U}^{t} - {x}_{{i}^{*}}$$

The procedure above may repeat until all points have been labeled in connection with the label propagation of the disclosed subject matter. The inventive concepts disclosed herein may be implemented and applied in numerous different ways as would be understood by one of ordinary skill in the art.

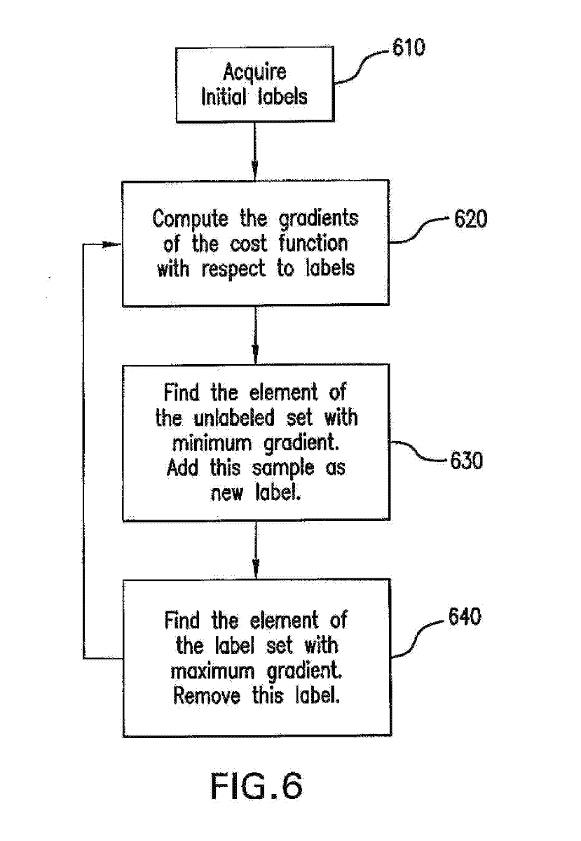

To handle errors in a label set, embodiments of the disclosed methods and systems can be extended to formulate a graph transduction procedure with the ability to handle mislabeled instances. A bidirectional greedy search approach can be used to simultaneously drive wrong label correction and new label inferencing. This novel mechanism can allow for automatic pruning of incorrect labels and maintain a set of consistent and informative labels. Modified embodiments of the systems and methods disclosed earlier may be equipped to more effectively deal with mislabeled samples and develop new “Label Diagnosis through Self Tuning” (LDST) systems and methods. FIG. 6 is a flow chart illustrating a labeling and unlabeling process of an LDST method in accordance with the presently disclosed subject matter. In step 610, the initial labels are acquired. They may be acquired, for example, by either by user annotation or from another resource, such as text based multimedia search results. In step 620, the gradient of the cost function with respect to label variable is computed based on the current label set. In step 630, a label is added from said unlabeled data set based on the greedy search, i.e. finding the unlabeled sample with minimum gradient value. In step 640, a label is removed from said label set based on the greedy search, i.e. finding the labeled sample with maximum gradient value. Steps 630 and 640 can be performed in reverse order without losing generalization, and the these steps can be executed a variable number of times (e.g., several new labels may be added after removing an existing label). Certain embodiments of the disclosed systems and methods update the computed gradients based on the new label set and repeat steps 630 and 640 to retrieve a refined label set.

Embodiments of the disclosed LDST systems and methods may execute a floating greedy search among the most beneficial gradient directions of Q on both labeled and unlabeled samples. Since the label regularizer term V associated with the current label variable Y, which converts the label variable into a normalized form Z=VY. The differential of the cost with respect to normalized label variable Z can be computed as:

$$\frac{\partial Q}{\partial Y} = AZ = AVY = \{ {P}^{T} LP + ( {P}^{T} - I ) ( P - I ) \} VY$$

The above calculation of gradient ∂Q/∂Y measures the change of the objective function in terms of the change of normalized label variable Z. In the disclosed embodiments of GTAM scheme, only one direction manipulation of increasing the labeled samples, i.e. changing the value of certain element of Y from 0 to 1, is discussed. The disclosed embodiments of LDST scheme extend to manipulate the label variable Y in both directions, labeling and unlabeling. The labeling operation may be carried out on the unlabeled nodes with the minimum value of the gradient min ∇_{z}_{ᵢⱼ}Q, while the unlabeling operation may be executed on the labeled nodes with the maximum value of the gradient max ∇ₛ_{ᵢⱼ}Q. The following equations summarize the bidirectional gradient decent search including both labeling and unlabeling operations to achieve the steepest reduction on the cost function Q for certain embodiments of the disclosed subject matter:

(i⁺,j⁺)=arg minₓ_{ᵢ}_{εX}_{ᵤ}_{,l≦j≦c}∇_{z}_{ᵢⱼ}Q^{t}; yᵢ_{⁺}_{,j}_{⁺}=1

(i⁻,j⁻)=arg maxₓ_{ⁱ}_{εX}_{ₜ}_{,l≦j≦c}∇_{z}_{ᵢⱼ}Q^{t}; yᵢ_{^{−}}_{,j}_{^{−}}=0

where (i⁺, j⁺) and (i⁻, j⁻) are the optimal elements of variable Y for labeling and unlabeling operations, respectively. Unlike the labeling procedure, the optimal elements for the unlabeling procedure may be investigated only on the portions of variable Yₗ where the element has the nonzero values. In other words, through each bidirectional gradient decent operation, one of the most reliable labels can be added and one of the least reliable labels can be removed. Again, since the label regularizer term V is associated with the current labels, it should be updated after each individual labeling or unlabeling operation. An embodiment in accordance with disclosed methods is illustrated in Table A below:

TABLE A

| | Input: data set X = {X_{L}, X_{U}}, the graph [symbol] {X, E} |
|---|---|
| | and the corresponding constants: |
| | normalized graph Laplacian L; |
| | propagation matrix P; |
| | node degree matrix D; |
| | gradient constant A = PLP + μ(P^{T} − I)(P − I); |
| | initial label variable Y⁰; |
| | label regularizer V⁰. |
| | Output: optimal prediction function F* and labels |
| | Y*. |
| 1 | iteration counter t = 0; |
| 2 | self tuning iteration number s; |
| 3 | while Xᵤ ≠ do |
| 4 | compute gradient ∇Q_{(VY)}^{t} = AV^{t}Y^{t}; |
| 5 | if t ≦ s then |
| 6 | (i⁻, j⁻) = max_{i,j} ∇Q_{(VY}_{ₗ}₎^{t}; |
| 7 | Yᵢ_{^{−}}_{,j}_{^{−}} = 0; |
| 8 | update Xₗ, Xᵤ; |
| 9 | recalculate V^{t}; |
| 10 | end |
| 11 | (i⁺, j⁺) = min_{i,j} ∇Q_{(VY}_{ᵤ}₎^{t}; |
| 12 | Yᵢ_{⁺}_{,j}_{⁺} = 1; |
| 13 | update X_{L}, X_{U}; |
| 14 | t = t + 1; |
| 15 | recalculate V^{t}; |
| 16 | end |
| 17 | return Y*, F* = PVY*. |

As shown in Table A, in the first s iterations of a disclosed method, a number of labeling and unlabeling operations are executed in order to eliminate problematic labels and add trustable new labels. In this self-tuning stage, one new label can be added to the labeled set after one unreliable label can be eliminated to maintain a fixed number of labels. Moreover, each individual operation of labeling and unlabeling can lead to an update of label regularization matrix v. After executing certain steps of label self tuning, the subsequent stage, which may be referred to as “LDST-propagation,” can be conducted to propagate labels to the unlabeled data set. The method may terminate when all the unlabeled samples are labeled. However, completed propagation in that fashion may result in a prohibitive computational cost if the data set is too large. Accordingly, in another embodiment, the iterative procedure can be terminated after obtaining enough labels and final prediction results can be computed using the following equation:

∇_{F}Q=0 [symbol] F*=PVY=(L/μ+I)^{-l}VY

Embodiments of the disclosed LDST systems and methods can be used to improve the results of text based image search results. In a disclosed embodiment, top-ranked images may be truncated to create a set of pseudo-positive labels, while lower-ranked images may be treated as unlabeled samples. LDST systems and methods can then be applied to tune the imperfect labels and further refine the rank list. Additional embodiments may be used on a variety of data set types, including text classification on webpages and to correctly identify handwritten data samples.

Although the disclosed subject matter as heretofore described has represented data in a single graph, in many applications, the data can naturally have multiple representations. For example, the web can be represented as different relationship maps, either by a directed graph with hyperlinks as edges or by an undirected similarity graph in the feature space of the Bag-of-Word model. For the applications of visual search, there are even more representations for images, such as SIFT features, GIST features, and sparse coding based features. Even with the same feature space, graph construction also varies in many ways, including kernel selection, sparsification, and edge weighting. The choices of data representation and the graph construction process result in a myriad of graphs. In this section, a new algorithm is described, which alternatively identifies the most confident unlabeled vertices for label assignment by considering multiple graphs, and combines the predictions from each individual graph to achieve more accurate labels over the entire label set.

A more efficient way to extend the GTAM method from a single graph to multiple graphs makes use of a novel approach that aggregates the most confident labels captured from multiple graphs. First, consider the transductive inference over an individual graph by solving arg min_{F}Q(F,Y) with the label variable Y fixed. Then the optimal prediction functions F={F1, . . . , Fq} can be derived for all the given graphs {G₁, . . . , Gₙ,} independently. The weighted combination over the prediction functions from individual graphs can be computed as: F=Σ_{q-1}^{m}α_{q}F_{q}, where α=[α₁, . . . , αₘ] are the weights, and large values of the weights indicates the most relevant graphs. The node regularizer is accordingly computed over multiple graphs as

$${v}_{ii} = \{ \begin{matrix}{\sum }_{q = 1}^{m} {α}_{q} \frac{{D}_{ii}^{q}}{{Σ}_{k} {Y}_{kj} {D}_{kk}} : & {Y}_{ij} = 1 \\ 0 : & otherwise .\end{matrix}$$

The above extension of label weight is based on the weighted sum of the normalized density, rather than the density from a single graph. Given the above combined predictions and normalized density, the following cost function can be defined over multiple graphs as:

$$Q ( F , Z , α ) = \frac{1}{2} {\sum }_{q = 1}^{m} {α}_{q} tr ( {F}_{q}^{⊤} {L}_{q} {F}_{q} ) + \frac{μ}{2} {\sum }_{q = 1}^{m} {{α}_{q} ( {F}_{q} - Z )}^{⊤} ( {F}_{q} - Z )$$

Although the minimization problem of the above cost function is nontrivial, a similar optimizing strategy as discussed earlier can be applied to derive local optimal solutions. The optimal prediction function over each graph can be derived as:

F*_{q}'=(L_{q}/μ+I)⁻¹Z=P_{q}Z

P_{q}=(L_{q}/μ+I)⁻¹,

where P_{q} is the propagation matrix over graph G_{q}. The cost function after replacing the optimal prediction function is written as:

$$Q ( Z , α ) = \frac{1}{2} {\sum }_{q = 1}^{m} {α}_{q} tr ( {Z}^{⊤} {A}_{q} Z )$$

$${A}_{q} = {P}_{q}^{⊤} {L}_{q} {P}_{q} + {μ ( {P}_{q} - I )}^{2} .$$

The partial derivatives of Q over Z and a can be computed as:

$$\frac{\partial Q}{\partial Z} = {\sum }_{q = 1}^{m} {α}_{q} {A}_{q} Z$$

$$\frac{\partial Q}{\partial {α}_{q}} = \frac{1}{2} tr ( {Z}^{T} {A}_{q} Z ) .$$

the update over the normalized label matrix Z is equivalent to updating the original label matrix Y, where Y and Z have one-to-one correspondence. Therefore, we identify the minimal element of the unlabeled part as:

$$( {i}^{*} , {j}^{*} ) = arg {min}_{{x}_{i} ∈ {X}_{u} , 1 \leq j \leq c} \frac{\partial Q}{\partial {Z}_{ij}}$$

and update the label matrix by setting Yᵢ*ⱼ*=1. The update of Y is indeed a labeling procedure that assigns the most confident unlabeled vertex with the proper label. With the updated Y, the node regularizer is re-computed, and Z is correspondingly updated. After finishing the update of the Y matrix, the coefficients a can also be updated using the gradient descent approach

$${α}_{q} = {α}_{q} - η \frac{\partial Q}{\partial {α}_{q}} ,$$

η is the step length. Since α={α_{q}}, q=1, . . . , m is constrained as Σ_{q} α_{q}=1 and α_{q}≧0, the α_{q} must be normalized after each iteration. The updating procedure of the elements in a can be interpreted as imposing higher weights to the most relevance graphs.

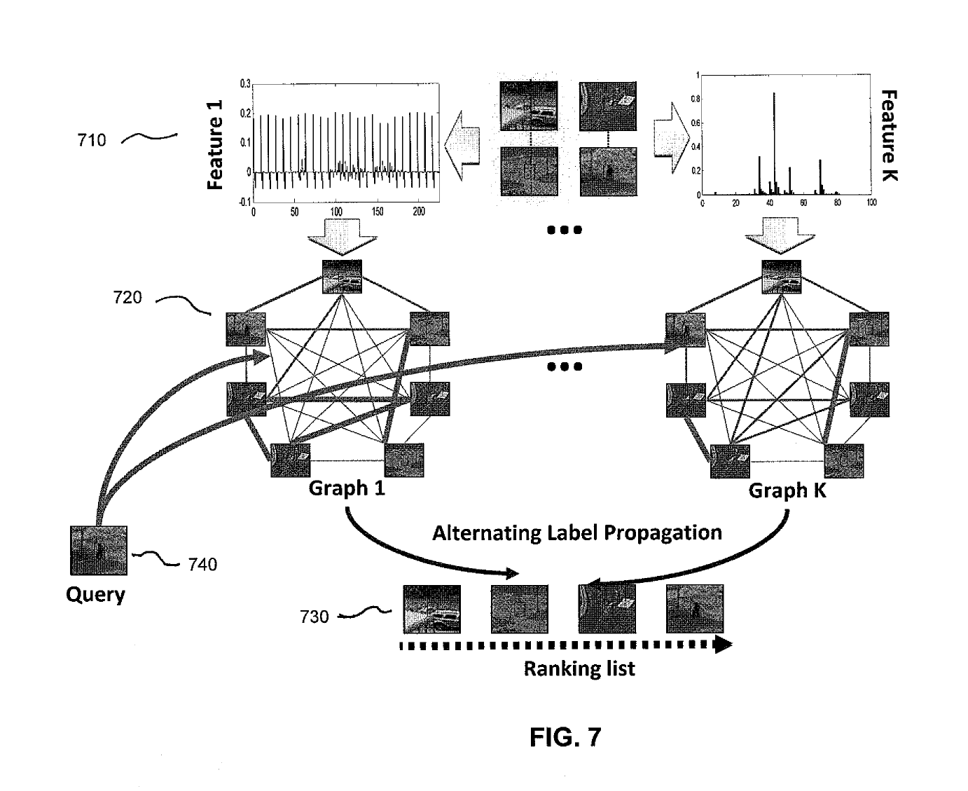

FIG. 7 is a diagram illustrating the application of a multi-graph method of data retrieval and label assignment. A plurality of data features 710 are represented as graphs 720. Query 740 is then applied against the plurality of graphs 720. Through the use of the algorithm described above, a confidence measure is used to capture the most relevant labels from the plurality of graphs, generating a ranking list 730.

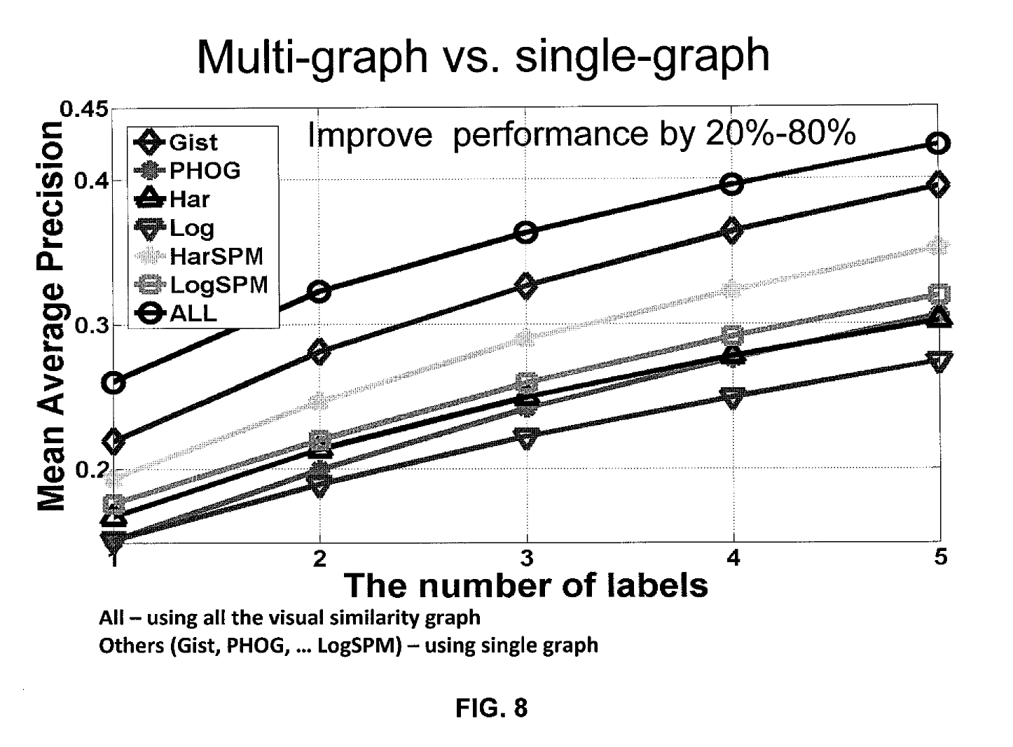

FIG. 8 is a graph comparing the precision of the multi-graph GTAM method against the single graph method, both of which are disclosed herein. The experiment was conducted using the Caltech 101 dataset which contains diverse object types. Six different features were used in the test, i.e, GIST, PHOG, Har, Log, HarSPM, LogSPM. The results of the ranking algorithm as conducted against individual graphs are compared with the multi-graph based alternating label propagation method. The latter being applied to all graphs. As shown by the results, the multi-graph method resulted in greater precision over the single-graph method.

The foregoing merely illustrates the principles of the disclosed subject matter. Various modifications and alterations to the described embodiments will be apparent to those skilled in the art in view of the teachings herein.

Embodiments of the disclosed systems and methods can also be used in biological applications. For example, systematic content screening of cell phenotypes in microscopic images may be useful in understanding gene and designing prescription drugs. However, manual annotation of cells and images in genome-wide studies is often cost prohibitive.

Gene function can be assessed by analyzing disruptive effects on a biological process caused by the absence or disruption of genes. With recent advances in fluorescence microscopy, imaging and gene interference techniques like RNA interference (RNAi), genome-wide high-content screening (HCS) has emerged as a powerful approach to systematically studying the functions of individual genes. HCS typically generates a large number of biological readouts, including cell size, cell viability, cell cycle, and cell morphology, and a typical HCS cellular image usually contains a population of cells shown in multi-channel signals, where the channels may include, for example, a DNA channel (indicating locations of nuclei) and a F-actin channel (indicating information of cytoplasm)

A critical barrier preventing successful deployment of large-scale genome-wide HCS is the lack of efficient and robust methods for automating phenotype classification and quantitative valuation of HCS images. Retrieval of relevant HCS images is especially important, and under prior methods, this was typically handled manually. Under these prior methods, generally, biologists first examine a few example images showing a phenotype of interest, manually browse individual microscopic images, and then assess the relevance of each image to the cellular phenotypes. This procedure is very expensive and relies on well trained domain experts. While some relevant automatic systems have previously been developed, they still rely heavily on biologist input and are especially subject to human error. Embodiments of the presently disclosed subject matter can be used to improve the procedure of discovering relevant microscopies given a small portion of labeled cells, leading to more accurate and efficient labeling and retrieval of relevant images, and offering significant improvements over existing methods

Embodiments of the presently disclosed subject matter can also be used to search images downloaded from Internet collections, such as photo sharing sites. In one embodiment, users may be provided a collection of images that have been filtered using keywords, and may quickly retrieve images of a specific class (for example, as discussed in connection with other embodiments herein, “Statue of Liberty”) through interactive browsing and relevance feedback. Using the particular system, users may quickly identify the images matching their specific interest by browsing and annotating returned results as positive (i.e., relevant to the target) or negative (i.e., irrelevant to the target). The label propagation method described herein may then be used to infer likelihood scores for each image in the collection indicating whether the image contains the desired target. A user can repeat the procedure of labeling and propagation to refine the results until the output results satisfy the user's requirements.

Certain embodiments of the disclosed systems and methods may also be used for web search improvements. Images on such web sharing sites often are already associated with textual tags, assigned by users who upload the images. However, it is well known to those skilled in the art that such manually assigned tags are erratic and inaccurate. Discrepancies may be due, for example, to the ambiguity of labels or lack of control of the labeling process. Embodiments of the disclosed systems and methods can be used to quickly refine the accuracy of the labels and improve the overall usefulness of search results from these types of internet websites, and more generally, to improve the usefulness and accuracy of internet multimedia searches overall.

Because the disclosed systems and methods are scalable in terms of feature representation, other application specified features can also be utilized to improve the graph propagation.

While the systems and methods disclosed above provide significant improvements over other labeling methods, the performance of the presently disclosed systems and methods may be degraded if a given set of labels is not reliable. Such problems arise in applications such as web image searches that use noisy textual tags. Therefore, novel and efficient graph-based methods that can correct incorrect labels and infer new labels through a bidirectional and alternating optimization process are also important. Particular embodiments of these systems and methods may automatically identify the most suitable samples for manipulation, labeling or unlabeling, and estimate a smooth classification function over a weighted graph. Unlike prior graph based approaches, embodiments of these systems and methods may employ a bivariate objective function and iteratively modify label variables on both labeled and unlabeled samples.

The foregoing merely illustrates the principles of the disclosed subject matter. Various modifications and alterations to the described embodiments will be apparent to those skilled in the art in view of the teachings herein.

Further, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

1. A method for labeling multimedia objects comprising:
storing a multimedia affinity graph in one or more memories, wherein said affinity graph represents a group of multimedia data samples as nodes and comprises edges measuring relatedness among data samples;
storing a multimedia label set in said one or more memories, wherein the labels in said label set correspond to a subset of said multimedia data samples;
calculating an classification function based on the initial label set and weights of the affinity graph using a processor associated with said one or more memories, wherein calculating said optimization function comprises iteratively performing at least updating an existing label in said label set or predicting a new label for a sample using said processor; and
outputting a set of labeled multimedia objects using said processor.

2. The method of claim 1 wherein said multimedia label set is input by a user.

3. The method of claim 1 wherein said multimedia label set is automatically input.

4. The method of claim 1, wherein iteratively predicting a new label comprises automatically selecting the most informative data sample, predicting its corresponding class and labeling the corresponding data sample.

5. The method of claim 1, wherein updating an existing label in said label set comprises using said processor to perform a greedy search among the gradient direction of said classification function.

6. The method of claim 1, wherein each labeled data sample is further normalized based on a regularization matrix calculated using members of a corresponding class and connectivity degrees of the corresponding nodes in the graph.

7. The method of claim 1, wherein calculating an classification function comprises incremental calculation using graph superposition, wherein a newly added label is incorporated incrementally without calculating the optimal classification function using all labels.

8. The method of claim 1 wherein noisy labels are replaced.

9. The method of claim 8, wherein replacing noisy labels comprises adding one or more new labels for every label that is removed.

10. The method of claim 9, wherein replacing noisy labels or predicting new labels comprises updating a node regularization matrix.

11. The method of claim 1, wherein replacing noisy labels or predicting new labels comprises minimizing an objective function.

12. A method for changing noisy labels in a data set comprising:
calculating an objective function based on a label set and a classification function over at least one of a labeled data set and an unlabeled data set using a processor;
performing a greedy search among gradient directions of said classification function to modify the objective function using said processor;
removing a label from said data set based on said greedy search of said classification function using said processor.

13. The method of claim 12 further comprising adding one or more labels to said label set based on said greedy search among gradient directions of said classification function using said processor.

14. The method of claim 13 further comprising updating a node regularization matrix.

15. The method of claim 12, wherein calculating an classification function comprises incremental calculation using graph superposition, wherein a newly added label is incorporated incrementally without calculating the optimal classification function using all labels.

16. The method of claim 12 wherein performing a greedy search among gradient directions of said classification function comprises performing a bidirectional search.

17. The method of claim 12 wherein removing a label comprises unlabeling previously labeled nodes that have the maximum value of the gradient function.

18. The method of claim 13 wherein adding one or more labels comprises labeling one or more previously unlabeled nodes having the minimum values of the gradient function.

19. A system for labeling multimedia objects comprising:
one or more memories storing a multimedia affinity graph, wherein said affinity graph represents a group of multimedia data samples as nodes and comprises edges measuring relatedness among data samples, and storing a multimedia label set, wherein the labels in said label set correspond to a subset of said multimedia data samples;
a processor coupled to said one or more memories, wherein said processor:
calculates a classification function based on the initial label set and weights of the affinity graph, wherein calculating said optimization function comprises iteratively performing of updating an existing label in said label set or predicting a new label for a sample; and
outputs a set of labeled multimedia objects.

20. The system of claim 19 wherein said multimedia label set is input by a user using an input device coupled to said one or more memories.

21. The system of claim 19 wherein said multimedia label set is automatically input.

22. The system of claim 19, wherein iteratively predicting a new label comprises automatically selecting the most informative data sample, predicting its corresponding class and labeling the corresponding data sample using said processor.

23. The system of claim 22 wherein iteratively updating said label set is based on a greedy search among the gradient direction of said classification function performed by said processor.

24. The system of claim 19, wherein each labeled data sample is further normalized based on a regularization matrix calculated using members of a corresponding class and connectivity degrees of the corresponding nodes in the graph.

25. The system of claim 19, wherein calculating a classification function comprises incremental calculation using graph superposition, wherein a newly added label is incorporated incrementally without calculating the optimal classification function using all labels.

26. The system of claim 19 wherein noisy labels are replaced using said processor.

27. The system of claim 26, wherein replacing noisy labels comprises adding one or more new labels using said processor for every label that is removed and said.

28. The system of claim 27, wherein replacing noisy labels or predicting new labels comprises updating a node regularization matrix using said processor.

29. The system of claim 19, wherein replacing noisy labels or predicting new labels comprises minimizing an objective function using said processor.

30. A system for changing noisy labels in a label set comprising:
a processor instructed to:
calculate an objective function based on a classification function and a label set using a processor;
perform a greedy search among gradient directions of said classification function using said processor; and
remove a label from said data set based on said greedy search of said classification function.

31. The system of claim 30 wherein said processor adds one or more labels to said label set based on said greedy search among gradient directions of said classification function.

32. The system of claim 31 wherein where said processor further updates a node regularization matrix.

33. The system of claim 30 wherein performing a greedy search among gradient directions of said classification function by said processor comprises performing a bidirectional search.

34. The system of claim 30 wherein removing a label by said processor comprises unlabeling previously labeled nodes that have the maximum value of the gradient function.

35. The system of claim 31 wherein adding one or more labels by said processor comprises labeling one or more previously unlabeled nodes having the minimum values of the gradient function.

36. A computer readable media containing digital information which when executed cause a processor to:
calculate a classification function based on a initial label set and weights of an affinity graph, wherein said affinity graph represents a group of multimedia data samples as nodes and comprises edges measuring relatedness among data samples, wherein calculating said optimization function comprises iteratively performing at least updating an existing label in said label set or predicting a new label for a data sample; and
output a set of labeled multimedia objects.

37. The media of claim 36 wherein iteratively predicting a new label comprises automatically selecting the most informative data sample, predicting its corresponding class and labeling the corresponding data sample.

38. The media of claim 37 wherein said digital information when executed causes said processor to update an existing label in said label set based on a greedy search among the gradient direction of said classification function.

39. The media of claim 36 wherein said digital information when executed further causes said processor to normalize each labeled data sample based on a regularization matrix calculated using members of a corresponding class and connectivity degrees of the corresponding nodes in said affinity graph.

40. The media of claim 36, wherein calculating a classification function comprises incremental calculation using graph superposition, wherein a newly added label is incorporated incrementally without calculating the optimal classification function using all labels.

41. The media of claim 36, where said digital information when executed further causes said processor to replace noisy labels.

42. The media of claim 41, wherein replacing noisy labels comprises adding one or more new labels for every label that is removed.

43. The media of claim 42, wherein replacing noisy labels or predicting new labels comprises updating a node regularization matrix.

44. The media of claim 36, wherein replacing noisy labels or predicting new labels comprises minimizing an objective function.

45. A computer readable media containing digital information which when executed cause a processor to:
calculate an objective function based on a label set and a classification function over at least one of a labeled data set and an unlabeled data set;
perform a greedy search among gradient directions of said classification function to modify the objective function;
remove a label from said label set based on said greedy search of said classification function.

46. The media of claim 45 wherein said digital information when executed further cause a processor to add one or more labels to said label set based on said greedy search among gradient directions of said classification function.

47. The media of claim 46 wherein said digital information when executed further cause a processor to update a node regularization matrix.

48. The media of claim 45 wherein performing a greedy search among gradient directions of said classification function comprises performing a bidirectional search.

49. The media of claim 45 wherein removing a label comprises unlabeling previously labeled nodes that have the maximum value of the gradient function.

50. The media of claim 46 wherein adding one or more labels comprises labeling one or more previously unlabeled nodes having the minimum value of the gradient function.

51. A method for normalizing labels associated with data samples from data classes of different sizes comprising:
storing in one or more memories an affinity graph, wherein said affinity graph represents a group of data samples as nodes and comprises edges measuring relatedness among data samples, and a label set, wherein the labels in said label set correspond to a subset of said data samples;
calculating a regularization matrix based on class members of said data samples and the connectivity degrees of nodes corresponding to said data samples in the graph;
normalizing labels associated with data samples by label weights, wherein said normalization is based on said regularization matrix

52. A system for normalizing labels associated with data samples from data classes of different sizes comprising:
one or more memories storing an affinity graph, wherein said affinity graph represents a group of data samples as nodes and comprises edges measuring relatedness among data samples, and storing a label set, wherein the labels in said label set correspond to a subset of said data samples;
a processor instructed to:
calculate a regularization matrix based on corresponding class members of said data samples and the connectivity degrees of nodes corresponding to said data samples in the graph;
normalize labels associated with data samples by label weights, wherein said normalization is based on said regularization matrix

53. A computer readable media containing digital information which when executed cause a processor to:
access an affinity graph from one or more memories, wherein said affinity graph represents a group of data samples as nodes and comprises edges measuring relatedness among data samples;
access a label set from said one or more memories, wherein the labels in said label set correspond to a subset of said data samples;
calculate a regularization matrix based on class members of said data samples and the connectivity degrees of nodes corresponding to said data samples in the graph;
normalize labels associated with data samples by label weights, wherein said normalization is based on said regularization matrix.

54. A method for labeling multimedia objects comprising:
storing a plurality of multimedia affinity graphs in one or more memories, wherein each of the plurality of affinity graphs represents one or more features of a group of multimedia data samples as nodes and comprises edges measuring relatedness among data samples;
storing a multimedia label set in said one or more memories, wherein the labels in said label set correspond to a subset of said multimedia data samples;
calculating the optimal prediction functions for each of the plurality of affinity graphs;
calculating the weighted combination over the prediction functions for each of the plurality of affinity graphs resulting in a weight assigned to each affinity graph wherein larger weight values indicate a higher degree of relevance for the corresponding affinity graph;
calculating an classification function based on the initial label set and weights of the affinity graphs using a processor associated with said one or more memories, wherein calculating said optimization function comprises iteratively performing at least updating an existing label in said label set or predicting a new label for a sample using said processor; and
outputting a set of labeled multimedia objects using said processor.

55. A system for labeling multimedia objects comprising:
one or more memories storing a plurality of multimedia affinity graphs, wherein each of the plurality of affinity graphs represents one or more features of a group of multimedia data samples as nodes and comprises edges measuring relatedness among data samples, and storing a multimedia label set, wherein the labels in said label set correspond to a subset of said multimedia data samples;
a processor coupled to said one or more memories, wherein said processor:
calculates the optimal prediction functions for each of the plurality of affinity graphs;
calculates the weighted combination over the prediction functions for each of the plurality of affinity graphs resulting in a weight assigned to each affinity graph wherein larger weight values indicate a higher degree of relevance for the corresponding affinity graph;
calculates a classification function based on the initial label set and weights of the affinity graphs, wherein calculating said optimization function comprises iteratively performing of updating an existing label in said label set or predicting a new label for a sample; and
outputs a set of labeled multimedia objects.
